(19) United States
(12) Patent Application Publication
(10) Pub. No.: US 2025/0008974 A1
(43) Pub. Date: Jan. 9, 2025

(54) ELECTRICAL FIELD TREATMENT DEVICE FOR EDIBLE OIL AND ELECTRICAL FIELD TREATMENT METHOD FOR EDIBLE OIL

(71) Applicant: GIANT CO., LTD., Tokyo (JP)

(72) Inventors: Joonseok LEE, Tokyo (JP); Takahiko ITO, Tokyo (JP); Takashi ISOBE, Tokyo (JP)

(21) Appl. No.: 18/293,293

(22) PCT Filed: Apr. 28, 2022
(86) PCT No.: PCT/JP2022/019238

§ 371 Date: Aug. 22, 2024

(30) Foreign Application Priority Data
Jul. 30, 2021 (JP) 2021-125261

(51) Int. Cl. A23D 9/04; A23D 9/06; A47J 37/12; C11B 3/00

(52) U.S. Cl. CPC A23D 9/04; A23D 9/06; A47J 37/129; C11B 3/005

(57) ABSTRACT

It is an object of the present invention to provide a novel technique related to electric field treatment of edible oil.

The present invention is an electric field treatment device for edible oil, the device including: an energization unit that is capable of being installed in at least one of side surface regions of an oil reservoir having a heating unit, wherein the heating unit is capable of heating a side surface and/or a bottom surface of the oil reservoir, and is capable of forming heat convection of the edible oil in both directions of the side surface region including the energization unit in the oil reservoir and a central region in the oil reservoir, and the energization unit is capable of applying an alternating electric field to the edible oil provided in the oil reservoir, includes at least two electrodes having a gap or a hole which is a path of heat convection of the edible oil and locally increases an electric field intensity applied to the edible oil, and applies the alternating electric field.

### TECHNICAL FIELD

The present invention relates to an electric field treatment device for edible oil and a method thereof.

### BACKGROUND ART

There has been an attempt to apply an alternating electric field corresponding to an electrostatic wave to edible oil to perform electric field treatment, suppress oxidation of the edible oil, and extend the life of the edible oil.

Patent Literature 1 discloses an invention related to a fryer including: a metal container containing edible oil; a heater that heats the edible oil; and an AC voltage generator that applies an AC voltage (at this time, a weak current of 5 mA or less) of 10 V or more and 10 kV or less to the container in an insulated state, wherein the temperature rise of the edible oil by the heater is controlled by applying the AC voltage to the container.

The invention described in Patent Literature 1 is an invention intended to provide a fryer that can achieve energy saving as compared with the related art. According to the present invention, the temperature of the edible oil can be maintained in an appropriate temperature range by applying an AC voltage to the edible oil to thereby lower the output required for the fryer.

Patent Literature 2 discloses an invention related to a fryer including: an oil reservoir configured to store edible oil and heat and cook food; opposed plate antennas that are erected opposite to the oil reservoir; a drive unit that drives the opposed plate antennas to generate an electromagnetic wave having a frequency of 10 kilohertz to 150 kilohertz between the opposed plate antennas; and a heating unit configured to heat the edible oil stored in the oil reservoir from 120 degrees Celsius to 200 degrees Celsius to cook the food.

An object of the invention described in Patent Literature 2 is to provide a fryer that provides a cooked food having extremely excellent taste by cooking food in a space in which an electromagnetic wave having a frequency in a predetermined range is generated. According to the present invention, the taste of the cooked food can be further improved.

It is already known that effects such as shortening of cooking time, lowering of the temperature of oil used during cooking, prevention of oxidation and deterioration of edible oil, and improvement in taste of the cooked food can be obtained by applying an electric field to the edible oil for cooking, but it can be understood that there is room for development in order to maximize the effects.

### CITATION LIST

### Patent Literature

Patent Literature 1: JP 2016-158853 A
Patent Literature 2: JP 2016-129672 A

### SUMMARY OF INVENTION

### Technical Problem

It is an object of the present invention to provide a novel technique related to electric field treatment of edible oil.

### Solution to Problem

In order to solve the above problems, the present invention provides an electric field treatment device for edible oil, the device including an energization unit that is capable of being installed in an oil reservoir having a heating unit, wherein the energization unit is capable of applying an alternating electric field to edible oil provided in the oil reservoir, is capable of forming cavitation vibration in the edible oil by applying the alternating electric field, is capable of fragmenting moisture in the edible oil by forming the cavitation vibration, and is capable of emulsifying the edible oil and the moisture by fragmenting the moisture.

In a preferred mode of the present invention, the energization unit includes electrodes having a gap or a hole.

In a preferred mode of the present invention, the electrode has a comb shape.

In a preferred mode of the present invention, the energization unit includes a fitting capable of being hooked to an outer edge of the oil reservoir.

In a preferred mode of the present invention, the heating unit is capable of heating a side surface and/or a bottom surface of the oil reservoir, and is capable of forming heat convection of the edible oil in both directions of the side surface region including the energization unit in the oil reservoir and a central region in the oil reservoir.

In order to solve the above problems, the present invention provides an electric field treatment method for edible oil, the method including causing an energization unit that is capable of being installed in an oil reservoir having a heating unit, to perform a step of applying an alternating electric field to edible oil provided in the oil reservoir, a step of forming cavitation vibration in the edible oil by applying the alternating electric field, a step of fragmenting moisture in the edible oil by forming the cavitation vibration, and a step of emulsifying the edible oil and the moisture by fragmenting the moisture.

### Advantageous Effects of Invention

According to the present invention, it can be understood that it can contribute to maximization of effects such as shortening of cooking time, lowering of the temperature of oil used during cooking, prevention of oxidation and deterioration of edible oil, and improvement in taste of cooked food.

### BRIEF DESCRIPTION OF DRAWINGS

FIG. 1 is a schematic view of an electric field treatment device for edible oil according to an embodiment.

FIG. 2 is a schematic view of an energization unit according to an embodiment.

FIG. 3 is a schematic view of an energization unit according to an embodiment.

FIG. 4 is a schematic view of an energization unit according to an embodiment.

FIG. 5 is a schematic view of an energization unit installed in an oil reservoir according to an embodiment.

FIG. 6 is a schematic view of an energization unit according to an embodiment.

FIG. 7 shows an electric field evaluation result by an energization unit according to an embodiment.

FIG. 8 shows an electric field evaluation result by an energization unit according to an embodiment.

FIG. 9 is a schematic view of an energization unit according to an embodiment.

FIG. 10 is a schematic view of an energization unit according to an embodiment.

### DESCRIPTION OF EMBODIMENTS

### Embodiment

An embodiment of the present invention will be described below. The embodiment can be modified as appropriate on the basis of a configuration of a known technique or the like.

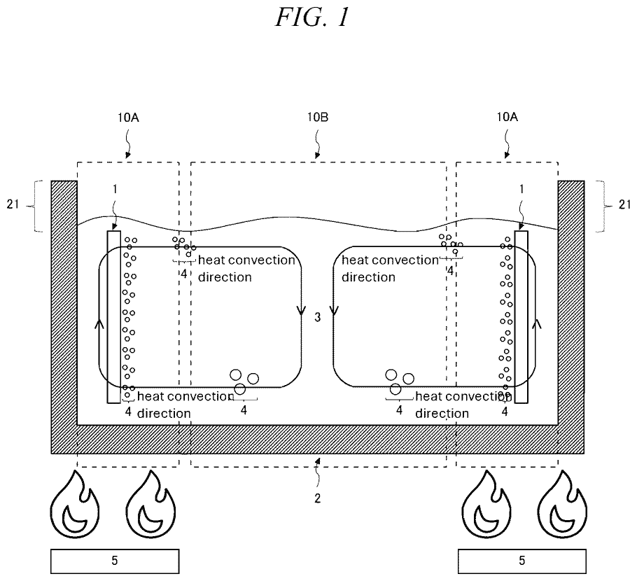

As illustrated in FIG. 1, an electric field treatment device for edible oil 3 includes an energization unit 1 that can be installed in an oil reservoir 2 having a heating unit 5.

The heating unit 5 can heat the side surface and/or the bottom surface of the oil reservoir 2, and can form heat convection of the edible oil 3 in both directions of a side surface region 10A including the energization unit 1 in the oil reservoir 2 and a central region 10B in the oil reservoir 2. Here, as an example, the heating unit 5 may be provided outside the oil reservoir 2 and based on an electric heating mechanism.

The energization unit 1 can apply an alternating electric field to the edible oil 3 provided in the oil reservoir 2, can form cavitation vibration in the edible oil 3 by applying the alternating electric field, can fragment moisture 4 in the edible oil 3 by forming the cavitation vibration, and can emulsify the edible oil 3 and the moisture 4 by fragmenting the moisture 4.

With such a configuration, the present invention can suppress formation of a hydrophobic/hydrophilic interface of the moisture 4 in contact with the edible oil 3 to reduce the volume per water droplet in oil, and thus can improve heat conduction from the oil to the food material. As a result, the present invention can achieve an effect of reducing bumping caused by releasing the moisture 4 from the food material in the edible oil 3 at the time of frying, an effect of reducing oil splatter that also causes bumping, an effect of reducing oil mist, an effect of reducing the amount of the edible oil 3 absorbed into the food material, and an effect of shortening the frying time due to the improvement in thermal efficiency accompanying the increase in the surface area of the moisture 4.

Note that the energization unit 1 may be immersed in the edible oil 3 by being installed at an outer edge 21 constituting the oil reservoir 2, or may be immersed in the edible oil 3 by being installed, for example, in a state of being gripped by the fitting 14, and there is no limitation on the installation mode thereof. In addition, the number of energization units 1 that can be installed in the oil reservoir 2 is not limited.

The energization unit 1 includes one or more of electrodes 11 and is connected to a controller. The energization unit 1 is provided on the side wall of the oil reservoir 2 or the vicinity thereof (corresponding to the side surface region 10A). Here, the shape and dimension of the energization unit 1 are not limited. There is no limitation as long as the proportion of the side surface region 10A in the oil reservoir 2 is less than 1.

The controller applies a voltage, a frequency, and the like to the energization unit 1. Furthermore, the controller may be a computer device including an arithmetic device such as a processor, and may be capable of communicating with another computer device via a network.

The voltage applied to the alternating electric field applied to the edible oil 3 has an advantageous effect, for example, in a range of 5 to 600 V.

The frequency of the alternating electric field applied to the edible oil 3 is not limited, and has an advantageous effect in a range of 25 kHz to 150 kHz. In addition, the frequency of the alternating electric field has an advantageous effect particularly at 30 kHz to 130 kHz, and further has an advantageous effect at 60 kHz to 100 KHz.

The current of the alternating electric field applied to the edible oil 3 has an advantageous effect, for example, in a range of 500 mA or less.

The electric field intensity of the alternating electric field applied to the edible oil 3 has an advantageous effect, for example, in a range of 100 to 100,000 V/m.

With such a configuration, a frequency band at which the effect of cavitation vibration applied to the polar compound is exhibited can be adopted in the application of the alternating electric field.

The one or more electrodes 11 included in the energization unit 1 have gaps or holes having one or more geometric shapes such as a circular shape, a triangular shape, a quadrangular shape, a polygonal shape, and a slit (strip) shape. The shape and dimension of the gap or hole are not limited.

With such a configuration, the electric field intensity can be locally increased in the vicinity of the energization unit such as a gap, thus making it possible to further cause cavitation vibration in the edible oil 3.

In addition, with such a configuration, the heat convection current of the edible oil 3 in the oil reservoir 2 is allowed to pass through gaps or the like, and the moisture 4 can be fragmented over the entire edible oil 3 by cavitation vibration and heat convection.

Here, the heat convection of the edible oil 3 in the oil reservoir 2 is preferably formed in both directions of the above-described side surface region 10A including the energization unit 1 and the central region 10B. Thus, the moisture 4 can be fragmented over the entire edible oil 3.

Note that the moisture 4 fragmented in the side surface region 10A moves to the central region 10B by heat convection, and at the same time, the moisture 4 newly generated in the edible oil 3 due to release from the food material in the oil reservoir 2 in the central region 10B moves to the side surface region 10A by heat convection.

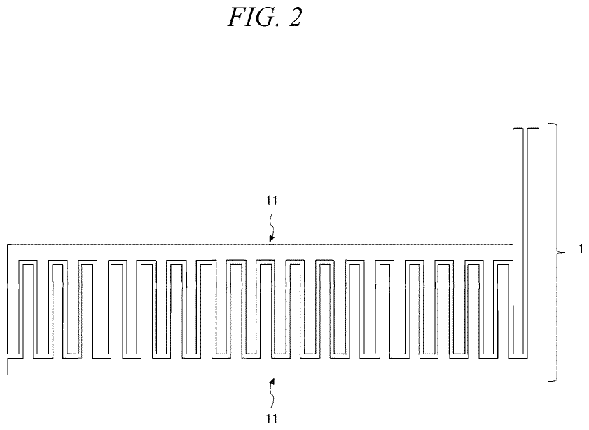

As illustrated in FIG. 2, the electrode 11 has a comb shape. As illustrated in FIG. 2, the energization unit 1 may be configured such that the two comb-shaped electrodes 11 are separated by a predetermined distance, and disposed close to each other to form gaps. At this time, it is a matter of course that the two electrodes 11 act as the electrodes 11 having different polarities.

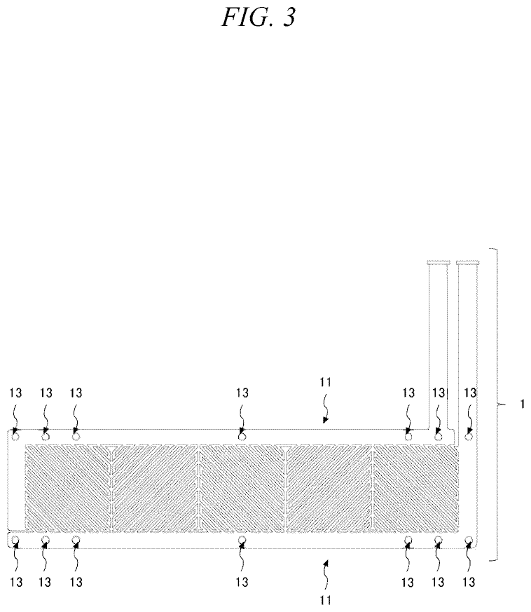

As illustrated in FIG. 3, the gaps in the comb-shaped electrode 11 may be made in the oblique direction. There is no limitation on the direction in which the gaps or the hole in the electrode 11 are made. The energization unit 1 may include a protective cover 12 that covers a part of the electrode 11 (for example, a portion where the gaps or the like does not appear). The two protective covers 12 sandwiching the electrode 11 from the left and right may be configured to be fastened with a bolt or the like via a fastening part 13.

With such a configuration, it is possible to increase the proportion of the gaps or the like per area of the energization unit 1 when viewed from the heat convection direction of the edible oil 3, and to thereby form, between the side surface region 10A and the central region 10B, heat convection of the moisture 4 more efficiently fragmented through the gaps or the like.

The electrode material and the coating material of the electrode 11 are not limited. The material of the electrode 11 is, for example, a conductive copper material.

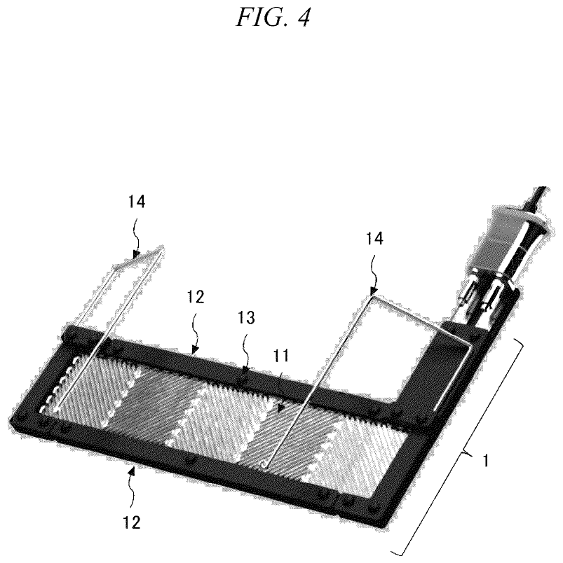

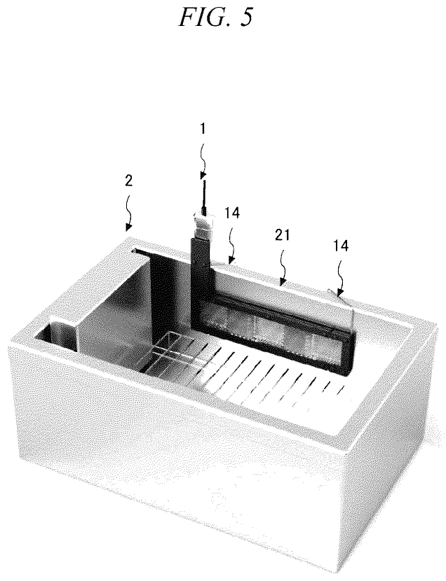

As illustrated in FIGS. 4 and 5, the energization unit 1 includes the fitting 14 that can be hooked on the outer edge 21. The fitting 14 has, by way of example, a torsion spring structure, and the installation of the energization unit 1 can be realized regardless of the dimensions of the outer edge 21 and the like.

The edible oil 3 preferably contains a polar compound such as a free fatty acid. Here, the amount of the polar compound (TPM value) of the edible oil 3 has an advantageous effect in a range of 1 to 24% or the like, and further has an advantageous effect in a range of 15% or more.

### Example 1

An example of the fragmenting of the moisture of the edible oil 3 according to the above-described configuration will be described below.

In Example 1, the test results of chicken cooked by heat treatment in the edible oil 3 are compared for the conditions A to D.

### <Condition A>

State of edible oil 3: fresh oil (TPM value: 11.5)
Set temperature: 180° C.
Frying time: 4 minutes 30 seconds
Weight of chicken: 512.5 g
Application of alternating electric field by energization unit 1: No

### <Condition B>

State of edible oil 3: fresh oil (TPM value: 11.0)
Set temperature: 180° C.
Frying time: 4 minutes
Weight of chicken: 490.5 g
Application of alternating electric field by energization unit 1: Yes

Here, the alternating electric field is applied by the energization unit 1 under the conditions of a current value of 0.6 mA, a voltage value of 100 V, and a frequency of 50 KHz.

### <Condition C>

State of edible oil 3: deteriorated oil (TPM value: 18.0)
Set temperature: 180° C.
Frying time: 4 minutes 30 seconds
Weight of chicken: 494.5 g
Application of alternating electric field by energization unit 1: No

### <Condition D>

State of edible oil 3: deteriorated oil (TPM value: 19.5)
Set temperature: 180° C.
Frying time: 4 minutes
Weight of chicken: 494.5 g
Application of alternating electric field by energization unit 1: Yes

Here, the alternating electric field is applied by the energization unit 1 under the conditions of a current value of 0.6 mA, a voltage value of 100 V, and a frequency of 50 kHz, similarly to the condition B.

Hereinafter, the moisture content and the like of the cooked chicken according to the conditions A to D are shown.

TABLE 1

| | Condition | Condition | Condition | Condition |
|---|---|---|---|---|
| | A | B | C | D |
| Energy [kcal/100 g] | 242 | 242 | 252 | 223 |
| Moisture [g/100 g] | 55 | 55.1 | 54.8 | 57.5 |
| Protein [g/100 g] | 19 | 20.4 | 19.4 | 17.4 |
| Lipid [g/100 g] | 14 | 14 | 16 | 12.4 |
| Carbohydrate | 9.9 | 8.6 | 7.7 | 10.5 |
| [g/100 g] | | | | |
| Ash [g/100 g] | 2.1 | 1.9 | 2.1 | 2.2 |
| Saturated fatty acid | 3.38 | 3.41 | 3.97 | 3.01 |
| [g/100 g] | | | | |
| Trans-fatty acid | 0.15 | 0.12 | 0.17 | 0.14 |
| [g/100 g] | | | | |
| Cholesterol (total | 110 | 120 | 110 | 110 |
| amount) [mg/100 g] | | | | |

Hereinafter, the evaluation results regarding the free amino acid composition of the cooked chicken according to the conditions A to D are shown.

TABLE 2

| | Condition | Condition | Condition | Condition |
|---|---|---|---|---|
| | A | B | C | D |
| Isoleucine [mg/100 g] | 18 | 19 | 16 | 18 |
| leucine [mg/100 g] | 31 | 31 | 27 | 30 |
| Lysine [mg/100 g] | 42 | 39 | 36 | 40 |
| Methionine | 11 | 11 | 9 | 10 |
| [mg/100 g] | | | | |
| Phenylalanine | 17 | 17 | 15 | 16 |
| [mg/100 g] | | | | |
| Tyrosine [mg/100 g] | 17 | 18 | 15 | 16 |
| Threonine [mg/100 g] | 29 | 30 | 28 | 29 |
| Valine [mg/100 g] | 25 | 26 | 22 | 24 |
| Histidine [mg/100 g] | 11 | 12 | 9 | 11 |
| Arginine [mg/100 g] | 42 | 39 | 37 | 39 |
| Alanine [mg/100 g] | 53 | 54 | 48 | 49 |
| Aspartic acid | 47 | 50 | 38 | 43 |
| [mg/100 g] | | | | |
| Glutamic acid | 290 | 270 | 270 | 280 |
| [mg/100 g] | | | | |
| Glycine [mg/100 g] | 33 | 33 | 33 | 34 |
| Proline [mg/100 g] | 26 | 26 | 21 | 22 |
| Serine [mg/100 g] | 41 | 41 | 35 | 37 |

As shown in the above table, it can be understood that moisture, protein, saturated fatty acid, cholesterol, isoleucine, tyrosine, threonine, valine, histidine, alanine, and aspartic acid tend to increase in the new oil by the application of the alternating electric field. Meanwhile, it can be understood that carbohydrate, ash, trans-fatty acid, lysine, arginine, and glutamic acid tend to decrease in the new oil by the application of the alternating electric field.

That is, it can be understood that, in the condition B, the result that prevents a significant decrease in the bitterness (e.g., isoleucine), the sweetness (e.g., threonine), and the umami (e.g., aspartic acid) constituting the taste, and that does not affect the taste, is achieved in a short frying time by the application of the alternating electric field.

In addition, as shown in the above table, it can be understood that any of moisture, carbohydrate, ash, and free amino acid tend to increase in the deteriorated oil by the application of the alternating electric field. Meanwhile, it can be understood that energy, protein, lipid, saturated fatty acid, and trans-fatty acid tend to decrease in the deteriorated oil by the application of the alternating electric field.

That is, it can be understood that, in the condition D, the result that the bitterness (e.g., isoleucine), sweetness (e.g., threonine), and umami (e.g., aspartic acid) constituting the taste are increased to improve the taste is achieved in a short frying time by the application of the alternating electric field.

It can be understood that due to the effects of suppressing formation of the hydrophobic/hydrophilic interface of the moisture 4 in contact with the edible oil 3, reducing the volume per water droplet in oil, and reducing bumping caused by releasing the moisture 4 from the food material in the edible oil 3 during frying and the short frying time achieved by improving heat conduction from the oil to the food material, a decrease in free amino acid as originally shown in the result of the condition C can be suppressed to be small in the condition D.

### Example 2

In Example 2, the evaluation results of chicken cooked by heat treatment and electric field treatment in the edible oil 3 are compared for the following conditions E to J.
<Condition E>: frequency 50 Hz
<Condition F>: frequency 20 KHz
<Condition G>: frequency 50 KHz
<Condition H>: frequency 80 KHz
<Condition I>: frequency 200 kHz
<Condition J>: frequency 1 MHz

Other conditions in the conditions E to J are shown below.

State of edible oil 3: deteriorated oil (TPM value:
13.0)
Set temperature: 180° C.
Frying time: 4 minutes
Electric field treatment time: 20 minutes
Weight of chicken: 498.9 g
Application of alternating electric field by energization unit 1: Yes

Here, the alternating electric field was performed on 13 L of the edible oil 3 at a current value of 0.6 mA and a voltage value of 100 V for 20 minutes, and frying cooking was performed on the edible oil 3 subjected to the electric field treatment for 4 minutes.

The results of the above conditions E to J are compared for the fried chicken according to Example 2 in the following table, and the effects thereof will be described. Note that three evaluators comprehensively evaluate in grades for the evaluation items of crispy texture, oil draining, moisture content (hardness of meat), color of batter, and odor transfer.

TABLE 3

| Frequency | 50 Hz | 20 kHz | 50 kHz | 80 kHz | 200 kHz | 1 MHz |
|---|---|---|---|---|---|---|
| Result | X | Δ | ◯ | ⊚ | Δ | X |

In the conditions E and J, the results are “x” (all of the three evaluators determined that there is a problem in any of the evaluation items). In the conditions F and I, the results are “Δ” (one or more evaluators determined that there is a problem in any of the evaluation items). In the condition G, the result is “∘” (all of the three evaluators determined that there is no problem in any evaluation item). In the condition H, the result is “⊙” (all of the three evaluators determined that it is good in any evaluation item). Therefore, it can be understood that the frying cooking can be suitably performed under the condition of 50 kHz, and the frying cooking can be more suitably performed under the condition of 80 KHz.

According to the present invention, it is possible to maintain or improve the cooking quality and to extend the life of the edible oil 3 by reducing the frying time.

### <Configuration Example of Energization Unit>

In a case where the electrode 11 included in the energization unit 1 is formed such that two electrodes are disposed to be separated from each other at a predetermined distance, the distance, the direction, the inclination angle, and the like for separating the electrodes are not limited. The two electrodes may have different shapes and sizes. The two electrodes may be composed of a plurality of positive electrodes and/or a plurality of negative electrodes as long as one of the two electrodes is a positive electrode and the other one of the two electrodes functions as a negative electrode, that is, the electrode 11 may be composed of at least two electrodes. The two electrodes 11 are preferably close to each other at a predetermined distance from the viewpoint of locally improving the electric field intensity. At this time, it is sufficient that the two electrodes 11 are partially close to each other, and a particularly strong electric field intensity is obtained in the region where the electrodes are close.

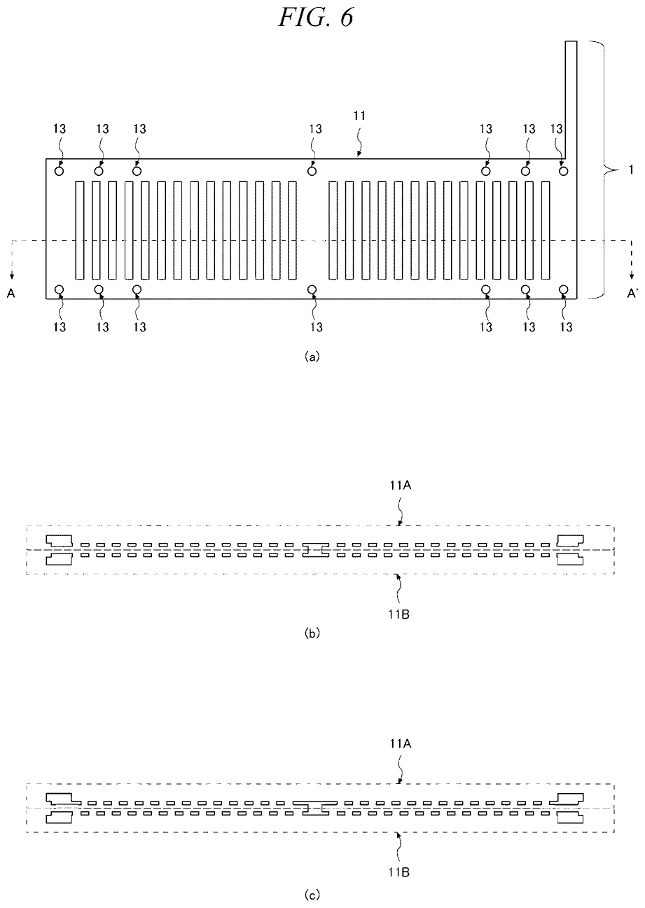

The electrode 11 included in the energization unit 1 may be formed in a slit shape as illustrated in FIG. 6. FIG. 6(a) is a front view of the energization unit 1, and FIG. 6(b) is a cross-sectional view taken along the line AA′ in FIG. 6(a). FIG. 6(c) illustrates a configuration example of different electrodes 11 in FIG. 6(b).

The energization unit 1 may include the protective cover 12 that covers and insulates a part of the electrode 11. The protective cover 12 of each electrode 11 may be configured to be fastened with a bolt or the like via the fastening part 13.

As illustrated in FIG. 6(b), the electrode 11 is composed of two electrodes including an electrode 11A and an electrode 11B. Here, the electrode 11A is formed as a positive electrode, and the electrode 11B is formed as a negative electrode. The electrode 11A may be formed as a negative electrode, and the electrode 11B may be formed as a positive electrode. In FIG. 6(b), the electrode 11A and the electrode 11B are disposed such that the electrode surfaces of the electrodes face each other, but as illustrated in FIG. 6(c), the electrode 11A and the electrode 11B may be disposed by shifting any one of the electrode 11A and the electrode 11B by a predetermined distance in the longitudinal direction (slit direction). Note that there is no limitation on the distance and direction in which the electrode 11A and the electrode 11B are shifted. Further, a part of the slit in the electrode 11A or the electrode 11B may be disposed so as to be shifted.

The structure of the electrode 11 is not limited to the slit shape as illustrated in FIG. 6, and may be a comb shape, a circular shape, a polygonal shape, or the like, and the two electrodes 11A and 11B may be disposed separated from each other in the direction perpendicular to the surface.

As the distance between the electrodes 11A and 11B decreases, the intensity of the electric field generated between the electrodes can be increased, and as the distance between the electrodes increases, the volume of the edible oil 3 filling between the electrodes can be increased. If the distance between the electrodes is too small, there is a risk of short circuit.

In the present example, the distance between the electrodes 11A and 11B can be 50 mm or less, more preferably 10 mm or less, more preferably 5 mm or less, and more preferably 3 mm or less. The distance between the electrodes 11A and 11B is preferably 0.1 mm or more. In the present example, the distance between the electrodes 11A and 11B is 2 mm.

As the distance between the slits and between the combs is small, the density of the electrode 11 can be increased, and as the distance is large, the amount of the heat convection current of the edible oil 3 can be increased. In addition, if the distance between the slits and between the combs is too small, there is a risk of a short circuit.

When the electrode 11 has a slit shape or a comb shape, the distance between the slits or the combs in the longitudinal direction can be preferably 50 mm or less, more preferably 10 mm or less, more preferably 5 mm or less, and more preferably 3 mm or less. The distance between the slits or the combs is preferably 0.1 mm or more. In the present example, the distance between the slits or the combs is 3 mm.

As illustrated in FIG. 6, by separating the two electrodes 11A and 11B in the plane direction, a high electric field intensity can be locally obtained between the electrodes or in the vicinity of the electrodes, and a risk of a short circuit caused by contact between the electrodes can be suppressed.

### <Evaluation of Each Configuration of Electrode>

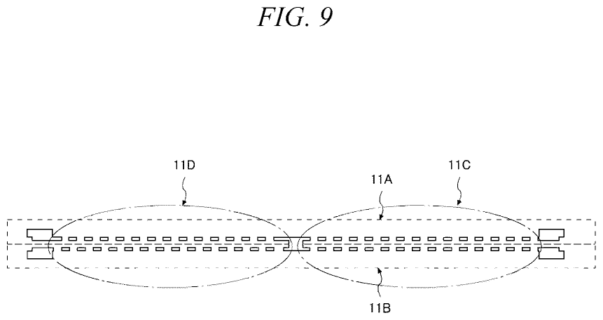

Effects such as shortening of the cooking time and prevention of oxidation/deterioration of the edible oil 3 in the present example can be evaluated by the electric field range (V/m) indicating the electric field intensity and the total volume (mm³) in which the electric field range in the oil reservoir 2 is obtained. An evaluation experiment of the electric field range obtained in the oil reservoir 2 and the total volume thereof was conducted for each structure (cases 1 to 4) of the electrode 11 of the energization unit 1. In the evaluation of the case 4, the energization unit 1 for evaluation, which has both the electrode structure of FIG. 6(b) and the electrode structure of FIG. 6(c) as illustrated in FIG. 9, is used.

### <Case 1>

Electrode structure: hole
Electrode arrangement: the positive electrode is disposed in one side surface region in the oil reservoir, and the negative electrode is disposed in one side surface region facing the positive electrode.
Distance between electrodes: 500 mm
Electrode area: 50 mm×200 mm
Voltage: 100 V (positive electrode), 0 V (negative electrode)
Oil reservoir: width 513 mm, depth 415 mm, height 60 mm
Edible oil relative permittivity: 2.6

### <Case 2>

Electrode structure: comb shape (see FIG. 3)
Electrode arrangement: the positive electrode and the negative electrode are disposed in one side surface region in the oil reservoir
Distance between electrodes: 3 mm (distance between combs)
Electrode area: 50 mm×200 mm
Voltage: 100 V (positive electrode), 0 V (negative electrode)
Oil reservoir: width 513 mm, depth 415 mm, height 60 mm
Edible oil relative permittivity: 2.6

### <Case 3>

Electrode structure: comb shape (see FIG. 2)
Electrode arrangement: the positive electrode and the negative electrode are disposed in one side surface region in the oil reservoir
Distance between electrodes: 3 mm (distance between combs)
Electrode area: 50 mm×200 mm
Voltage: 100 V (positive electrode), 0 V (negative electrode)
Oil reservoir: width 513 mm, depth 415 mm, height 60 mm
Edible oil relative permittivity: 2.6

### <Case 4>

Electrode structure: slit shape (see FIG. 9)
Electrode arrangement: the positive electrode and the negative electrode are disposed in one side surface region in the oil reservoir (shift distance: 1.5 mm in the slit direction)
Distance between electrodes: 2 mm
Distance between slits: 3 mm
Electrode area: 50 mm×100 mm (facing arrangement), 50 mm×100 mm (shifted arrangement)
Voltage: 100 V (positive electrode), 0 V (negative electrode)
Oil reservoir: width 513 mm, depth 415 mm, height 60 mm
Edible oil relative permittivity: 2.6

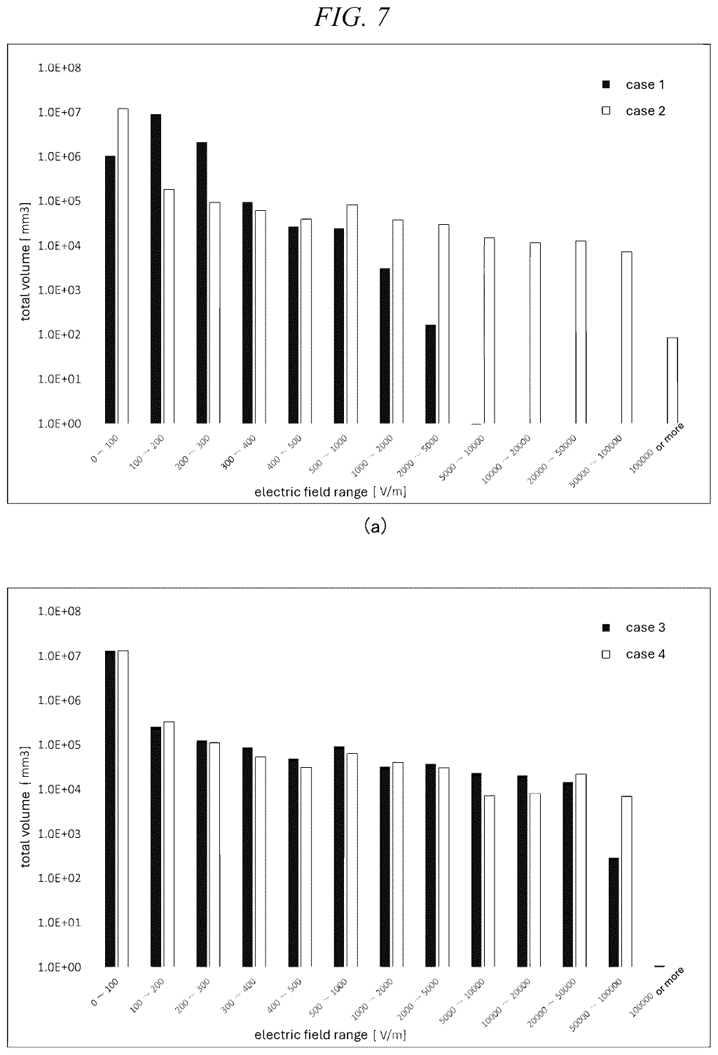

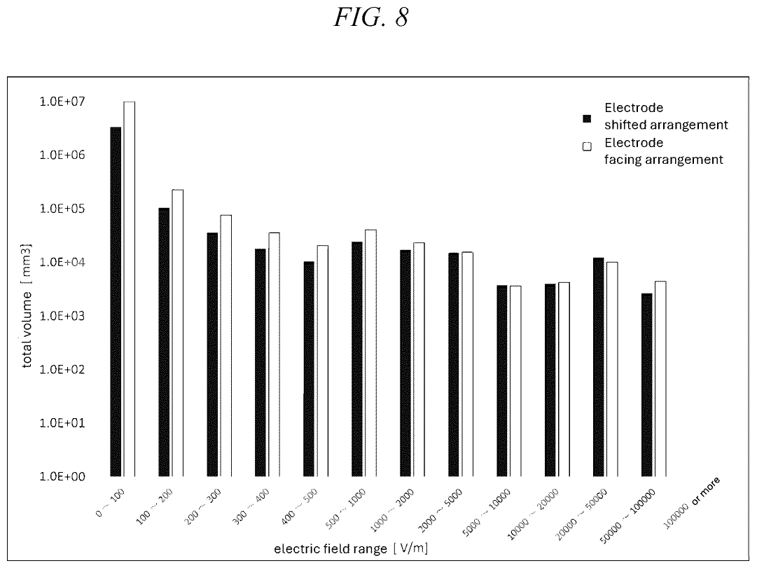

FIGS. 7 and 8 show evaluation results regarding the electric field range and the total volume thereof in the cases 1 to 4 described above.

FIG. 7(a) shows evaluation results regarding the electric field range and the total volume thereof in the cases 1 and 2. As shown in the evaluation results of FIG. 7(a), it can be understood that in the case 2, by forming the electrode 11 in a comb shape and making the distance between the electrodes close, the total volume of the electric field range of 400 V/m or more is increased, and high electric field intensity is locally obtained in the vicinity of the electrode 11.

FIG. 7(b) shows evaluation results regarding the electric field range and the total volume thereof in the cases 3 and 4. As shown in the evaluation result of FIG. 7(b), it can be understood that in the case 4, by forming the electrode structure in a slit shape and disposing the electrode 11A and the electrode 11B to be separated from each other in the plane direction, the total volume of the electric field range of 1,000 V/m or more becomes 1.16 E5 mm³, and high electric field intensity is locally obtained around the electrode 11. Further, it can be understood that in the case 3, by forming the electrode structure in a comb shape and making the distance between the electrodes close, the total volume of the electric field range of 1,000 V/m or more becomes 1.30 E5 mm³, and high electric field intensity is locally obtained around the electrode 11.

As described above, by making the distance between the electrodes close, the total volume of the high electric field range increases, so that the electric field treatment can be efficiently performed on the edible oil 3 in the vicinity of the electrode 11. In addition, even in the electrode 11 in which the risk of a short circuit is suppressed as in the electrode structure and the electrode arrangement of the cases 3 and 4, a total volume with a high electric field range is obtained, so that efficient electric field treatment of the edible oil 3 can be performed. The edible oil 3 is circulated by heat convection in both directions of a side surface region having the energization unit 1 of the oil reservoir 2 and a central region where frying cooking is performed, and is effectively subjected to electric field treatment with a high electric field range in the side surface region.

FIG. 8 shows evaluation results regarding the electric field range formed by a facing arrangement region 11C in which the electrode 11A and the electrode 11B are disposed facing each other and a shifted arrangement region 11D in which the electrodes are disposed to be shifted from each other in the case 4, and the total volume of the electric field range. According to the evaluation result of FIG. 8, the total volume of the electric field range of 1,000 V/m or more was 6.11 E4 mm³ in the case where the electrodes 11 were disposed facing each other, and the total volume of the electric field range of 1,000 V/m or more was 5.51 E4 mm³ in the case where the electrodes 11 were disposed to be shifted from each other. From the evaluation result of FIG. 8, it can be understood that in the electrodes 11A and 11B, high electric field intensity can be locally obtained in the vicinity of the electrode 11 in both the facing arrangement and the shifted arrangement, and in the facing arrangement, higher electric field intensity is obtained as compared with the shifted arrangement.

FIG. 9 is a cross-sectional view of the energization unit 1 with respect to the slit direction of the electrode 11, and the facing arrangement region 11C and the shifted arrangement region 11D are indicated by alternate long and short dash lines.

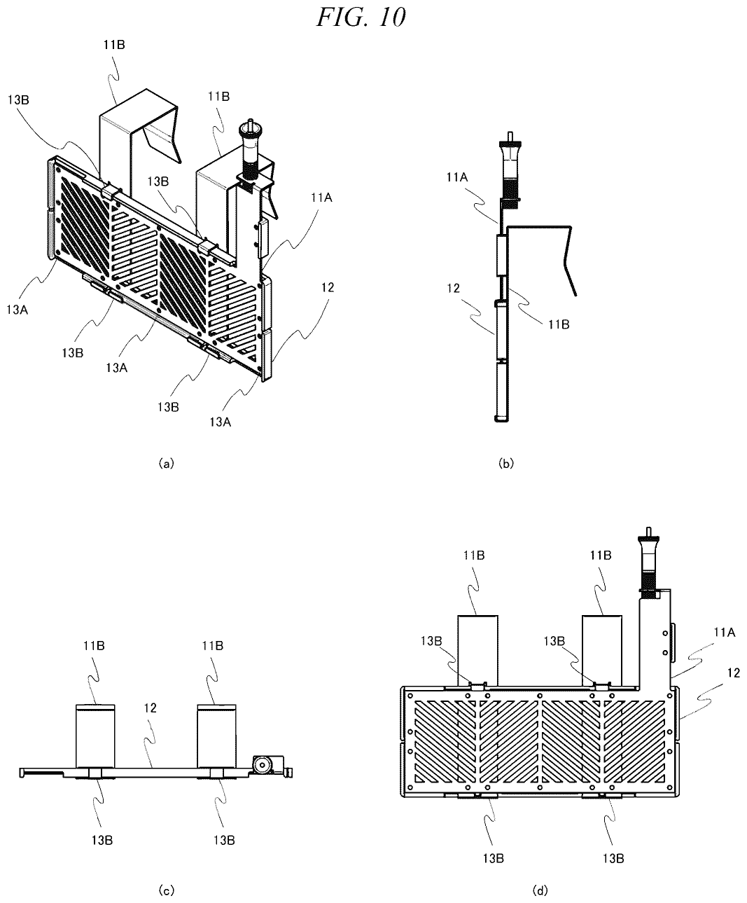

FIG. 10 is a configuration view of the energization unit 1 of the electric field treatment device according to the present embodiment. FIGS. 10(a) to(d) show a perspective view, a side view, a top view, and a front view of the energization unit 1, respectively.

In the energization unit 1, the electrode 11 is composed of at least two electrodes including the electrode 11A and the electrode 11B. The electrode 11B may be composed of a plurality of electrodes as exemplified in FIG. 10, and the number, arrangement, shape, size, and the like thereof are not limited. Here, the electrode 11B is connected to the oil reservoir 2 and is configured as a ground electrode. That is, a constant voltage is applied to each electrode 11B, and each electrode forms an electric field with the electrode 11A. Similarly, the electrode 11A may be composed of a plurality of electrodes.

The electrode 11B has a bent structure which is bent toward the outside of the oil reservoir 2 in the vicinity of the edge of the oil reservoir 2. The electrode 11B can be used as a fitting by hooking the bent structure on the edge portion of the oil reservoir 2.

The electrode 11A has holes or gaps. In FIG. 10, slits are formed as holes or gaps in the electrode 11A, but the number, direction, shape, position, and the like of the slits are not limited. Since the electrode 11A has holes or gaps, the edible oil can be suitably circulated without hindering heat convection.

The electrodes 11A and 11B may be disposed so as to be at least partially close to each other. In the region where the electrodes 11A and 11B are close to each other, the electric field intensity is locally improved, and the edible oil circulating by heat convection is subjected to electric field treatment particularly effectively in the region where high electric field intensity is obtained. In addition, by forming the plurality of electrodes 11B, heat convection is more suitably formed.

The energization unit 1 includes the protective cover 12 that insulates the electrode 11A from the electrode 11B. In FIG. 10, the protective cover 12 has a thickness in the plane direction of the electrode 11A and the electrode 11B, and separates the electrode 11A and the electrode 11B by a predetermined distance. The protective cover 12 is formed along a part or all of edges of the electrode 11A, and is connected to the electrode 11A by the fastening part 13A. As illustrated in FIG. 10, the shape and the like of the protective cover 12 are not limited as long as the protective cover 12 is configured not to block holes or gaps in the electrode 11A, for example, not to be disposed at the center of the electrode 11A. The protective cover 12 is also connected to the electrode 11B by the fastening part 13.

By adopting the electrode structure as described above, it is possible to more suitably realize maintenance or improvement of cooking quality and extension of the life of the edible oil 3 by reducing the frying time.

### REFERENCE SIGNS LIST

1 Energization unit
2 Oil reservoir
3 Edible oil
4 Moisture
5 Heating unit
10A Side surface region
10B Central region
11 Electrode

1. An electric field treatment device for edible oil, the device comprising:
an energization unit that is capable of being installed in at least one of side surface regions of an oil reservoir having a heating unit, wherein
the heating unit is capable of heating a side surface and/or a bottom surface of the oil reservoir, and is capable of forming heat convection of the edible oil in both directions of the side surface region including the energization unit in the oil reservoir and a central region in the oil reservoir, and
the energization unit is capable of applying an alternating electric field to the edible oil provided in the oil reservoir, includes at least two electrodes having a gap or a hole which is a path of heat convection of the edible oil and locally increases an electric field intensity applied to the edible oil, is capable of forming cavitation vibration in the edible oil by applying the alternating electric field, is capable of fragmenting moisture in the edible oil by forming the cavitation vibration, and is capable of emulsifying the edible oil and the moisture by fragmenting the moisture.

2. The electric field treatment device for edible oil according to claim 1, wherein at least one of the electrodes has a comb shape.

3. The electric field treatment device for edible oil according to claim 1, wherein at least one of the electrodes has a slit shape.

4. The electric field treatment device for edible oil according to claim 1, wherein
the energization unit includes a fitting capable of being hooked to an outer edge of the oil reservoir.

5. The electric field treatment device for edible oil according to claim 1, wherein the energization unit is installed in each of two side surface regions facing each other in the oil reservoir.

6. An electric field treatment method for edible oil, the method comprising:
causing a heating unit that heats a side surface and/or a bottom surface of an oil reservoir to perform a step of forming heat convection of the edible oil in both directions of side surface regions each including an energization unit in the oil reservoir and a central region in the oil reservoir; and
causing an energization unit that is capable of being installed in at least one of the side surface regions of the oil reservoir having the heating unit, includes at least two electrodes having a gap or a hole which is a path of heat convection of the edible oil and locally increases an electric field intensity applied to the edible oil,
to perform a step of applying an alternating electric field to the edible oil provided in the oil reservoir, a step of forming cavitation vibration in the edible oil by applying the alternating electric field, a step of fragmenting moisture in the edible oil by forming the cavitation vibration, and a step of emulsifying the edible oil and the moisture by fragmenting the moisture.
